(19) United States
(12) Patent Application Publication
(10) Pub. No.: US 2016/0103550 A1
(43) Pub. Date: Apr. 14, 2016

(54) SENSING SYSTEM AND METHOD

(71) Applicant: KAPIK INC., Toronto (CA)

(72) Inventor: William Martin SNELGROVE, Toronto (CA)

(21) Appl. No.: 14/878,229

(22) Filed: Oct. 8, 2015

Related U.S. Application Data
(60) Provisional application No. 62/061,534, filed on Oct. 8, 2014.

(51) Int. Cl. G06F 3/041; G06F 3/047; G06F 3/0488; G06F 3/044

(52) U.S. Cl. CPC G06F 3/0416; G06F 3/044; G06F 3/047; G06F 3/0488; G06F 2203/04104; G06F 2203/04111

(57) ABSTRACT

In capacitive touch panels arrays, self and mutual capacitances of embedded wires in rows and columns are measured to estimate the position of fingers, styli and the like. For precise measurement of position and for sensitivity to small objects it is desirable to have these wires closely spaced; but this causes the number of connections to the panel to become large and problematic. Sensing lines may share connections by permuting their order, thus reducing the number of pins required on a touch-panel controller chip; in cabling between a touch panel and its controller; and in memory requirements for a touch-panel controller.

### CROSS-REFERENCE TO RELATED APPLICATION

This application claims the benefit of U.S. Provisional Patent Application 62/061,534, Filed Oct. 8, 2014, the entire contents of which are incorporated herein by reference.

### FIELD

The present invention relates to a system and method for sensing touches, and in particular, system and method for sensing touches in capacitative panels.

### BACKGROUND

Capacitive touch panels, such as those used in smart ‘phones and tablets, embed a grid of transparent wires in their screens. These sense lines are connected through cabling to circuits that measure the capacitances of and between these lines to detect the presence and position of fingers, styli, brushes and the like.

In a typical touch panel, there are two layers of sense lines—one with wires disposed in rows and one with wires disposed in columns. These sense lines are typically spaced at a pitch of approximately 6 mm, both in the row and column directions. FIG. 1 shows generally at 100 a cross-section of a touch panel 104 containing column sense lines 108, with two fingers 112 and 116 in proximity. A cross-section showing rows would be similar, but with the row sense lines vertically separated from the columns.

Fingers 112 and 116 increase the self-capacitance of sense lines 108, not just directly beneath the fingers but generally nearby according to the laws of electrostatics. They also reduce the mutual capacitance between lines, in particular between row and column sense lines, through a kind of shielding effect.

FIG. 2 shows generally at 200 capacitances for 17 rows of an exemplary touch panel with two fingers nearby. The values labelled on the y-axis of the graph are differences from baseline capacitance due to the presence of the fingers: baseline capacitance would be on the order of 100 pF for an exemplary panel, and would vary with position due to edge effects and mounting hardware: thus small changes in a large variable are generally detected. Trace 204 shows the effect of finger 112 alone, with elevated capacitance at rows 5 and 6 but also with substantial fringing capacitance for several rows in each direction. Trace 208, similarly, shows the effect of finger 116 alone, and trace 212 shows the combined effect of both fingers. These are the measurements from which the positions of the fingers are estimated.

Note that traces 208 and 212 show a consistent signature shape: in mathematical terms they are approximately samples of a function of the form k/(1+cx̂2), where x is the position of the finger along the panel, and where c and k are indicative of size and height. Estimation of finger position typically proceeds using knowledge of this signature: for example by correlating measured data with an expected signature.

FIG. 200 showed self-capacitance, and for a panel touched at a single point it is enough to locate the touch in the x direction (by sensing columns) and the y direction (by sensing rows). For a multi-touch system there is ambiguity in pairing x coordinates with y coordinates, so mutual-capacitance sensing is used. It is known to use hybrid sensing, in which mutual capacitance measurements are used just for disambiguation and the accurate position sensing is done using the simpler self-capacitance methods.

At this 6 mm line spacing, a tablet with a 300 mm diagonal could include 30 columns and 40 rows. In this typical touch panel all 70 of these sense lines are connected to 70 pins of an integrated circuit through wiring around the periphery of the panel and then through connectors and a cable. This is a large number of pins, adding substantial cost to the circuit package and connectors and forcing the periphery of the panel to be enlarged. The panel, connector and cable wiring are typically made at a fine pitch to reduce some of these costs, and this in turn increases parasitic capacitances that reduce sensitivity.

The typical 6 mm spacing is fine enough to detect the presence of a finger, which might typically be represented as a grounded conductor of approximately 8 mm diameter, but it is generally desired to resolve the position of the finger to within 1 mm. This super-resolution can be obtained, but generally involves making measurements with signal-to-noise ratios of typically 20 dB or better. High signal-to-noise ratios in turn are generally associated with large drive voltages or long sensing times. High drive voltages are not compatible with advanced integrated-circuit technologies, and long sensing times are not compatible with the fast response desired for a good user experience.

Compounding this problem, users wish to be able to use a stylus or brush on these panels, and these devices can be much smaller than a finger: a 1 mm stylus tip is not unusual. The small size of the target to be sensed reduces its effect on sense-line capacitances, especially when it is midway between sense lines.

This situation is not unique to capacitive touch panels, but shared by any sense technology having a grid of sense lines. There are also one-dimensional sensors having only a single layer of sense lines but with the same wiring problem, and optical and acoustic techniques are known to localize objects in three dimensions.

The grid geometry can also be generalized to use more complex patterns, such as zig-zags, and can be generalized to take advantage of more than two layers. It is also known to drive row and column lines from both ends, in order to reduce RC delays in the very thin sense lines, and it is known to subdivide a panel into two or four subpanels, dividing row and column sense lines at the centre of the panel.

Traditional grid-based sensing is based on the concept of making measurements that, to the greatest extent possible, estimate inputs independently: in this case isolating the effects of different fingers to different sense lines. This often leads to the problems discussed above.

### SUMMARY

In accordance with an aspect of the invention, there is provided a sensing system for sensing a position. The sensing system includes a panel having a first section and a second section. The sensing system further includes a plurality of sense lines disposed in both the first section and the second section. A first portion of each sense line in the plurality of sense lines is disposed in the first section in a first order. A second portion of each sense line in the plurality of sense lines is disposed in the second section in a second order. The first order is different from the second order to provide a distinct pattern. The sensing system also includes a sensor chip having a plurality of inputs. Each input is for connecting to a sense line from the plurality of sense lines for receiving measured data from the plurality of sense lines. The sensor chip is configured to correlate the measured data with the first order and the second order of the plurality of sense lines to determine the position on the panel based on the measured data.

The sensor chip may be configured to detect a capacitance from the plurality of sense lines.

The capacitance detected may be a mutual capacitance for multitouch sensing.

The capacitance detected may be a self-capacitance for single touch sensing.

The sensor chip may be configured to apply a simplex optimization to correlate the measured data.

The sensor chip may be configured to detect a combination of self-capacitance and mutual-capacitance from the plurality of sense lines.

The plurality of sense lines may include at least 5 sense lines.

In accordance with another aspect of the invention, there is provided a method of sensing a position. The method involves disposing a plurality of sense lines on a panel such that a first portion of each sense line in the plurality of sense lines is disposed in a first order in a first section and a second portion of each sense line in the plurality of sense lines is disposed in a second order in a second section. The first order is different from the second order to provide a distinct pattern. The method further involves connecting each sense line of the plurality sense lines to an input of a sensor chip. In addition, the method involves receiving measured data from the plurality of sense lines. Furthermore, the method involves correlating the measured data with known signatures of the plurality of sense lines to determine the position on the panel based on the measured data.

Receiving measured data may involve receiving capacitance data from the plurality of sense lines.

The capacitance data received may be a mutual capacitance for multitouch sensing.

The capacitance data received is a self-capacitance for single touch sensing.

Correlating the data may involve applying a simplex optimization.

Receiving measured data may involve receiving a combination of self-capacitance and mutual-capacitance from the plurality of sense lines.

Receiving measured data may involve receiving measured data from at least 5 sense lines.

In accordance with another aspect of the invention, there is provided a sensing system for sensing a position. The sensing system includes a panel. The sensing system further includes a plurality of sense lines disposed in both a first orientation and a second orientation. A first portion of each sense line in the plurality of sense lines is disposed in the first orientation in a first order. A second portion of each sense line in the plurality of sense lines is disposed in the second orientation in a second order. The first order is different from the second order to provide a distinct pattern. The sensing system also includes a sensor chip having a plurality of inputs. Each input is for connecting to a sense line from the plurality of sense lines for receiving measured data from the plurality of sense lines. The sensor chip is configured to correlate the measured data with the first order and the second order of the plurality of sense lines to determine the position on the panel based on the measured data.

The sensor chip may be configured to detect a capacitance from the plurality of sense lines.

The sensor chip may be configured to apply a simplex optimization to correlate the measured data.

The first orientation may be a first set of parallel lines and the second orientation may be a second set of parallel lines.

The first set of parallel lines and the second set of parallel lines may be configured to determine two dimensional coordinates of the position.

The sensor chip may be configured to detect a combination of self-capacitance and mutual-capacitance from the plurality of sense lines.

The plurality of sense lines may include at least 5 sense lines.

The first set of parallel lines may be perpendicular to the second set of parallel lines.

### BRIEF DESCRIPTION OF THE DRAWINGS

Reference will now be made, by way of example only, to the accompanying drawings in which:

FIG. 1 shows a cross-section illustrating column sensing in a self-capacitance touch screen, with two fingers whose positions are to be sensed;

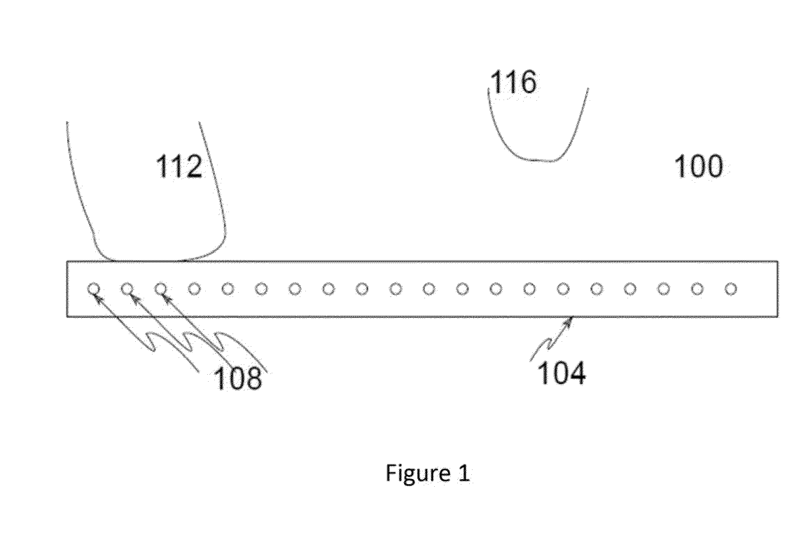

FIG. 2 shows self-capacitance profiles for sensing in the screen of FIG. 1, illustrating single-ended self-capacitance sensing without shared columns;

FIG. 3 shows self-capacitance profiles for sensing in the screen of FIG. 1, illustrating single-ended self-capacitance sensing with sharing of randomized column sensing;

FIG. 4 shows the self-capacitance profiles of FIG. 3 with the random permutation inverted;

FIG. 5 shows split row wiring with different permutations at left and right half-screens, providing two-dimensional sensing with one-dimensional wiring; and

FIG. 6 shows a plan view of a touch panel in accordance with an embodiment.

### DETAILED DESCRIPTION OF THE EMBODIMENTS

The present invention relates to a system and method for sensing capacitances in touch panels, wherein connections are reused in different parts of the panel in permuted order. This permits reduction in the costs of connections, such as of cabling and of pins on integrated circuits. The same technique may be applied more generally for sensors of other types, such as resistance or optical transmissivity, and to sensing in one or more dimensions. The invention may advantageously reduce the cabling and connectivity complexity and cost associated with capacitive touch panels and like sensors.

Reusing sense lines at different locations in the panel, in permuted order is disclosed. Thus, for example, if the first 5 columns of a panel use sense lines [0, 1, 2, 3, 4] the next 5 columns can reuse them in the order [2, 0, 4, 1, 3]: thus line 0 is used in columns 0 and 6, line 1 in columns 1 and 8, and so on. Only 5 wires are actually cabled back to the sensor chip, and only 5 pins are used on that chip, but it senses ten columns.

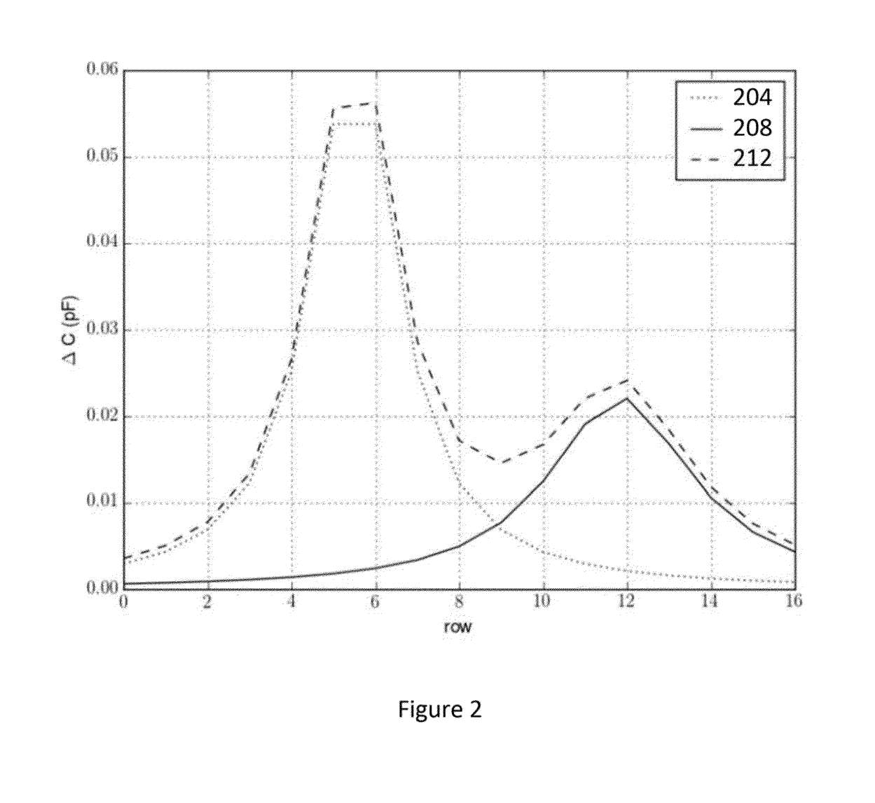

Because the order of lines is permuted, it is possible to avoid ambiguity: if the second set of columns reused the sense lines in the order [0, 1, 2, 3, 4, 5] there would be no significant difference in the measured response for a finger in the left half and one in the right half of the screen; but by using permutation the signature or pattern of a touch can be changed from the simple curves of FIG. 2 to something mathematically distinct and subsequently identifiable.

For two-dimensional sensing, this technique can be used both for rows and for columns; and by extension can be used for a third dimension in a suitable sense technology. Where non-Manhattan (e.g. zig-zag) wiring patterns are used, permutation and reuse can still be used for the same purpose.

A set of lines can be reused multiple times in different permutations, further reducing connectivity requirements.

Permutations may advantageously be chosen so that touch signatures are as different as possible, for example by avoiding common subsequences.

Permutations may advantageously be chosen so that differential drive or receive on adjacent pairs in one sequence give differential drive or receive of nearby pairs in the permutation, thus preserving desirable immunity to electromagnetic interference.

The technique is applicable both to self-capacitance and mutual-capacitance sensing, and for hybrid sensing.

The known technique of cutting rows and columns at the screen center can be generalized to allow individual lines to be cut to different lengths. This creates a situation in which the x signature depends on y position and vice-versa, further enriching the data.

Estimation of finger position can be done by extending traditional techniques of correlating measured data with signatures. It can also advantageously be done using the preferred optimization algorithms of a mathematical technique called compressive sensing, which takes individual measurements that mix the inputs, such that a single input affects as many measurements as possible or practical. The inputs may be mixed in a manner that maximizes this effect. Compressive sensing may work well when there is prior knowledge that the dimensionality of the inputs is small and may include use of simplex methods and L1 norms and which take advantage of a priori knowledge about the number of fingers expected: correlation-based methods do not take advantage of this. They also do not take advantage of a priori knowledge of physical constraints, such as that fingers are positive—a signature cannot be multiplied by a negative coefficient. Optimization methods may advantageously use position estimates from one frame to provide initial conditions for the next frame, making computation practical.

Permutations may advantageously be chosen to avoid repetitions of lines or of pairs, either in their original or mirror-image forms. Thus for example choosing a simple mirror-image [0, 1, 2][2, 1, 0] places line 2 in two adjacent columns, thereby effectively making it wider; and makes it impossible to tell whether a symmetrical signature is in the left- or right-half panel.

Permutations may advantageously be chosen so that differential drive or sensing of adjacent lines in the original sequence, which has desirable properties with regards to avoiding interference, maps to differential drive of close (but not necessarily or even desirably adjacent) pairs in the permutation.

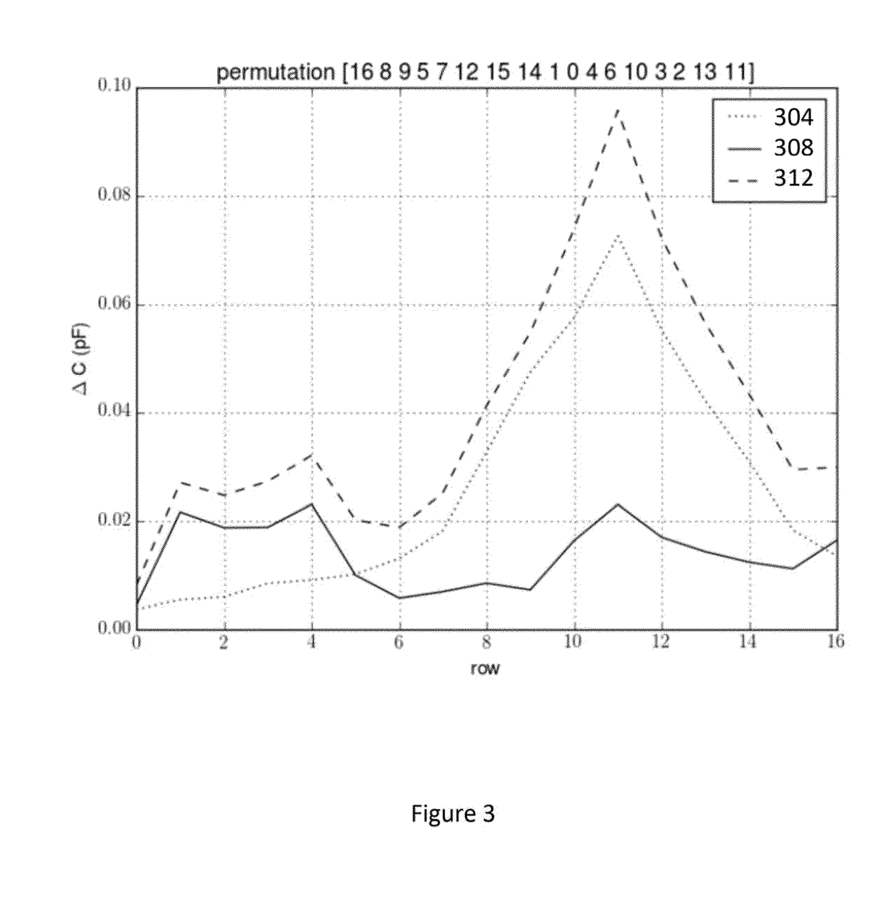

FIG. 3 shows generally at 300 capacitance data for an embodiment in which panel 200 having 17 column sense lines numbered [0, 1, . . . , 16] at 6 mm pitch is replaced by a panel having 34 column sense lines at 3 mm pitch, the first 17 lines being the original lines in the original order, but more closely spaced, and the second group of lines reusing the same sense lines in the (arbitrarily chosen) order [16, 8, 9, 5, 7, 12, 15, 14, 1, 0, 4, 6, 10, 3, 2, 13, 11].

Trace 304 shows the effect of finger 112 alone that peaks to a higher value than trace 204: this is because the finer 3 mm column pitch includes a sample better centered on the finger than the original 6 mm pitch. Trace 304 is also about twice as far to the right and approximately twice as wide, but this is simply a scaling artefact: a unit step in the x axis now corresponds to 3 mm, not 6. Trace 304 is also slightly asymmetric, with columns 8, 9 and 16 reading a little high: this is a leakage effect, because columns 16, 8 and 9 are adjacent in the next group, and the right-hand tail of the capacitance distribution is still substantial there.

Trace 308 shows the effect of finger 116 alone. This looks very different from the smooth shape of trace 208: samples of the smooth physical profile of fringing capacitance have been shuffled into a pseudo-random order because the sense-line order has been permuted. This distinct signature of a touch on the right half of the panel is what makes it possible to distinguish between touches in the left and right halves despite the fact that they are sharing sense lines.

Trace 312 shows the combined effect of fingers 112 and 116. This is the data that is measured for this two-touch case, and analyzed to estimate the positions of fingers 112 and 116.

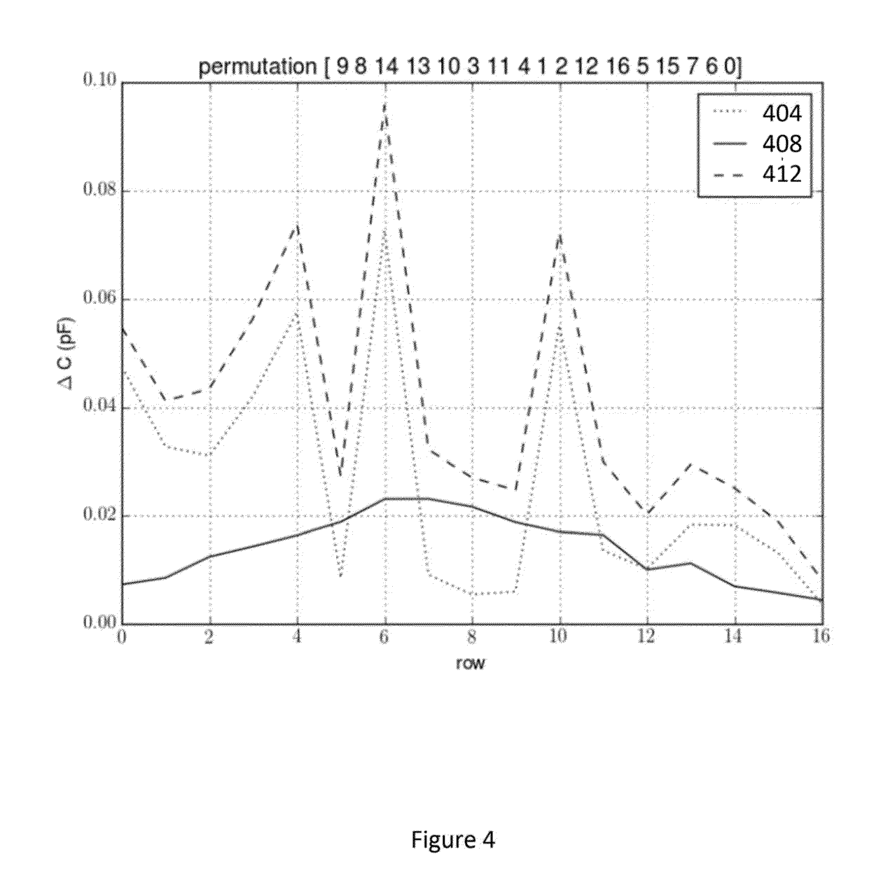

FIG. 4 shows generally at 400 the same data as shown in FIG. 3, but with the x-coordinates rearranged in the order [9, 8, 14, 13, 10, 3, 11, 4, 1, 2, 12, 16, 5, 15, 7, 6, 0] so as to invert the permutation. Now trace 408, corresponding to finger 116, has a smooth k/(1+cx̂2) shape, whereas trace 404, corresponding to finger 112, appears to have been randomized. Trace 412 again represents the net effect of fingers in the left and right halves.

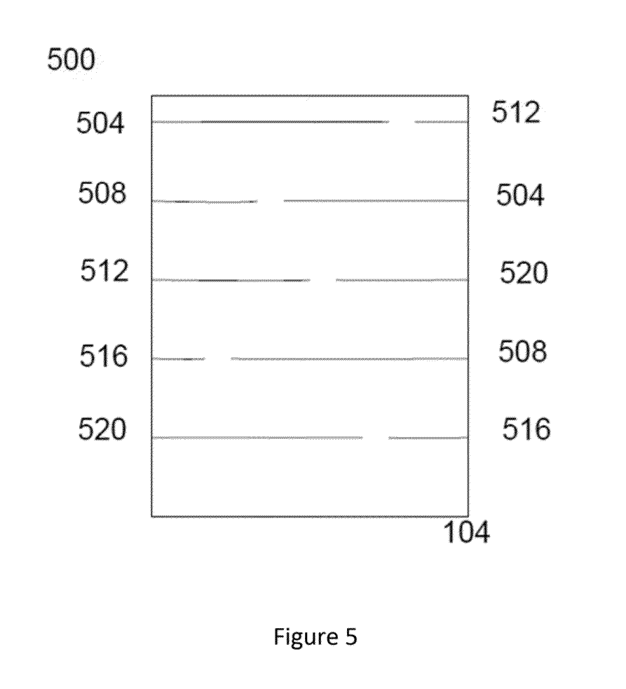

FIG. 5 shows generally at 500 a plan view of a touch panel 104 having row sense lines 504, 508, 512, 516 and 520, each row sense line being cut in the panel and driven by signals from each end. The topmost row sense line, for example, is connected to signal 504 on the left side, but to signal 512 at the right side. A finger touching the panel at the left has one signature, and a finger touching near the right has another signature; and position in the vertical direction is also sensed. This technique allows sensing in one dimension to be used to disambiguate in the other.

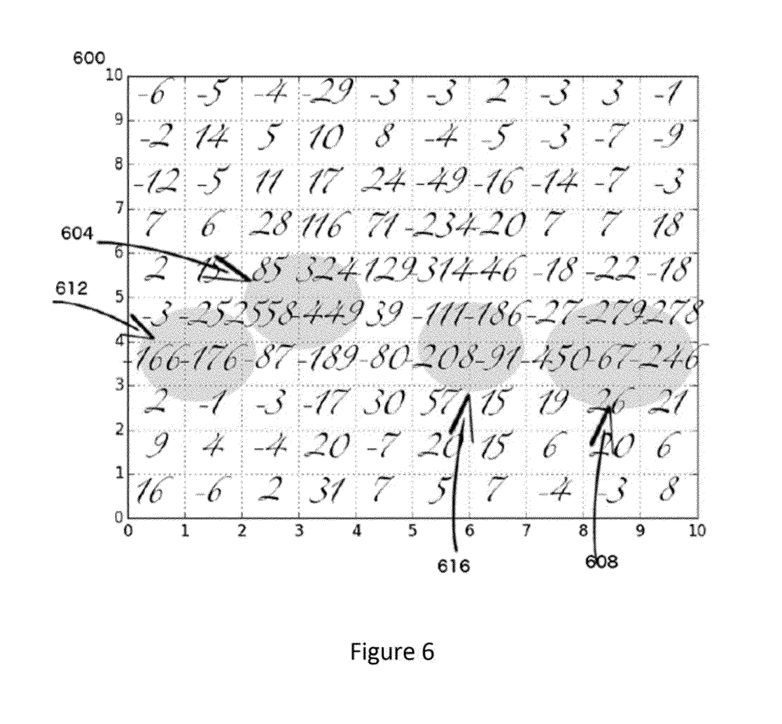

FIG. 6 shows generally at 600 a plan view of a small touch panel having column sense lines 604, 608 and 612, and also having reused sense lines 504, 508, 512, 516 and 520, giving a 10*3 two-dimensional array requiring only 8 wires. Either or both dimensions can be implemented with a permuted sense-line scheme.

In one embodiment, estimation of finger position is done using an optimizer, such as one using the Nelder-Mead algorithm. This generally involves evaluation of an expression for expected capacitance as a function of estimate finger positions to produce a measure function for model error.

In another embodiment of an estimator a Newton conjugate-gradient method is used, which further generally involves calculation of a Jacobian for the model error.

In another embodiment convex optimization is used.

In any embodiment of an estimator using an optimizer it is desirable to have a good initial estimate of finger positions. Correlation methods can be used for this.

The permutation [16, 8, 9, 5, 7, 12, 15, 14, 1, 0, 4, 6, 10, 3, 2, 13, 11] used in the example for FIGS. 3 and 4 has several undesirable properties. Placing the original and permuted sequences next to one another, as they are in the panel, yields a sequence [0, 1, 2, 3, 4, 5, 6, 7, 8, 9, 10, 11, 12, 13, 14, 15, 16, 16, 8, 9, 5, 7, 12, 15, 14, 1, 0, 4, 6, 10, 3, 2, 13, 11]. In this sequence two copies of line 16 are adjacent to each other, which is undesirable because the effect is of one double-width line, which reduces resolution. Similarly, the pair [8, 9] appears twice, so that this pair of lines does not distinguish between the left and right halves of the screen. Similarly, the pairs [15, 14], [1, 0] and [3, 2] in the right-hand half-screen are just mirror images of pairs in the left-hand half-screen: because finger profiles tend to be symmetric this means that these pairs do not distinguish the right-hand side of a finger in the left half-screen from the left-hand side of a finger in the right half-screen, and vice versa.

These problems are not fatal, because the fine line pitch enabled by the present invention mean that information about a given finger is spread over many sense lines, allowing disambiguation of local repetitions: but it may be preferable to avoid such ambiguities.

With sequences up to length 4 it may be shown by simple search that there is no permutation that avoids repeating lines or pairs. At length 5 there are 6 choices: [0, 2, 4, 1, 3], [0, 3, 1, 4, 2], [1, 3, 0, 2, 4], [1, 3, 0, 4, 2], [2, 0, 3, 1, 4] and [2, 0, 4, 1, 3], so it is possible to sense 10 lines with 5 connections.

At length 7 it is possible to use each line three times without repeating any line or pair: for example [0, 1, 2, 3, 4, 5, 6, 0, 2, 4, 1, 5, 3, 6, 1, 3, 0, 4, 6, 2, 5]. Thus it is possible to sense 21 lines with as few as 7 connections. A simple counting argument shows that each repetition adds two to the number of forbidden neighbours, so it is contemplated to use at least 2n+1 connections so as to reuse connections n times with this preferable constraint. Accordingly, the number of lines that can be sensed increases quadratically with the number of connections allowed.

Another counting argument relates equations and unknowns: if the position of k fingers is to be detected, each having an x- and a z-coordinate, there are 2k unknowns and it is expect to generally require 2k measurements. A five-connection system, for example, gives enough for 2 fingers plus one equation of redundancy, which can be used either to improve resolution or to detect unexpected inputs.

Partial permutations may also be used while avoiding repetitions: thus for example the sequence [0, 1, 2, 0] reuses line 0, but not the others; and [0, 1, 2, 3, 4, 0, 2, 4, 1, 3, 0] similarly uses line 0 three times but the others only twice. Lines can be omitted (from the end) without causing repetitions. This may be desirable if the number of lines needed is smaller than what is provided by the technique: for example, given that 7 connections can handle 21 lines with complete permutations, if only 19 are required the last two can be omitted.

Removing the constraint that forbids repetition of a pair in reverse order increases the amount of reuse that can be allowed: for example permitting [0, 1, 2, 1, 0] and [0, 1, 2, 3, 0, 2, 1, 3]. The ambiguity referred to above (between the left edge of a finger on the right-hand side and the right edge on the left-hand side) can be removed using, for example, context from nearby lines.

An embodiment of panel wiring for the common case of two-dimensional sensing simply uses one of the embodiments described above for each of the row and column dimensions. Sensing can be purely of self-capacitance (for single-touch), purely of mutual capacitance (for basic multitouch) or a hybrid technique in which mutual-capacitance measurements are used to disambiguate self-capacitance data.

In another embodiment, panel wiring is cut at approximately the center of the panel and different permutations applied to each end of the sets of sense lines. This allows the use of measurements made in one direction (for example, x) to give some information about position in the other dimension (for example, y).

In another embodiment, panel wiring is cut.

While specific embodiments have been described and illustrated, such embodiments should be considered illustrative only and should not serve to limit the accompanying claims.

What is claimed is:

1. A sensing system for sensing a position, the sensing system comprising:
a panel having a first section and a second section;
a plurality of sense lines disposed in both the first section and the second section, wherein a first portion of each sense line in the plurality of sense lines is disposed in the first section in a first order and wherein a second portion of each sense line in the plurality of sense lines is disposed in the second section in a second order, wherein the first order is different from the second order to provide a distinct pattern; and
a sensor chip having a plurality of inputs, each input for connecting to a sense line from the plurality of sense lines for receiving measured data from the plurality of sense lines, wherein the sensor chip is configured to correlate the measured data with the first order and the second order of the plurality of sense lines to determine the position on the panel based on the measured data.

2. The sensing system of claim 1, wherein the sensor chip is configured to detect a capacitance from the plurality of sense lines.

3. The sensing system of claim 2, wherein the capacitance detected is a mutual capacitance for multitouch sensing.

4. The sensing system of claim 2, wherein the capacitance detected is a self-capacitance for single touch sensing.

5. The sensing system of claim 1, wherein the sensor chip is configured to apply a simplex optimization to correlate the measured data.

6. The sensing system of claim 1, wherein the sensor chip is configured to detect a combination of self-capacitance and mutual-capacitance from the plurality of sense lines.

7. The sensing system of claim 1, wherein the plurality of sense lines includes at least 5 sense lines.

8. A method of sensing a position, the method comprising:
disposing a plurality of sense lines on a panel such that a first portion of each sense line in the plurality of sense lines is disposed in a first order in a first section and a second portion of each sense line in the plurality of sense lines is disposed in a second order in a second section, wherein the first order is different from the second order to provide a distinct pattern;
connecting each sense line of the plurality sense lines to an input of a sensor chip;
receiving measured data from the plurality of sense lines; and
correlating the measured data with known signatures of the plurality of sense lines to determine the position on the panel based on the measured data.

9. The method of claim 8, wherein receiving measured data comprising receiving capacitance data from the plurality of sense lines.

10. The method of claim 9, wherein the capacitance data received is a mutual capacitance for multitouch sensing.

11. The method of claim 9, wherein the capacitance data received is a self-capacitance for single touch sensing.

12. The method of claim 8, wherein correlating the data comprises applying a simplex optimization.

13. The method of claim 8, wherein receiving measured data comprises receiving a combination of self-capacitance and mutual-capacitance from the plurality of sense lines.

14. The method of claim 8, wherein receiving measured data comprises receiving measured data from at least 5 sense lines.

15. A sensing system for sensing a position, the sensing system comprising:
a panel;
a plurality of sense lines disposed in both a first orientation and a second orientation, wherein a first portion of each sense line in the plurality of sense lines is disposed in the first orientation in a first order and wherein a second portion of each sense line in the plurality of sense lines is disposed in the second orientation in a second order, wherein the first order is different from the second order to provide a distinct pattern; and
a sensor chip having a plurality of inputs, each input for connecting to a sense line from the plurality of sense lines for receiving measured data from the plurality of sense lines, wherein the sensor chip is configured to correlate the measured data with the first order and the second order of the plurality of sense lines to determine the position on the panel based on the measured data.

16. The sensing system of claim 15, wherein the sensor chip is configured to detect a capacitance from the plurality of sense lines.

17. The sensing system of claim 15, wherein the sensor chip is configured to apply a simplex optimization to correlate the measured data.

18. The sensing system of claim 15, wherein the first orientation is a first set of parallel lines and the second orientation is a second set of parallel lines.

19. The sensing system of claim 18, wherein the first set of parallel lines and the second set of parallel lines are configured to determine two dimensional coordinates of the position.

20. The sensing system of claim 19, wherein the first set of parallel lines is perpendicular to the second set of parallel lines.
